(19) United States
(12) Patent Application Publication
(10) Pub. No.: US 2018/0330631 A1
(43) Pub. Date: Nov. 15, 2018

(54) SYSTEM, APPARATUS, AND METHOD FOR SMALL UNMANNED AERIAL VEHICLES (SUAVs) USED FOR THE SIMULATION OF IMPROVISED EXPLOSIVE DEVICES AND OTHER SUAV TRANSPORTED DEVICES

(71) Applicant: Explotrain, LLC, Ft. Walton Beach, FL (US)

(72) Inventors: Charles Dean Preston, II, Shalimar, FL (US); Michael V. Malone, Ft. Walton Beach, FL (US); Michael J. Hopmeier, Ft. Walton Beach, FL (US)

(21) Appl. No.: 15/977,022

(22) Filed: May 11, 2018

Related U.S. Application Data
(60) Provisional application No. 62/504,812, filed on May 11, 2017.

(51) Int. Cl. G09B 9/00; F42B 8/14

(52) U.S. Cl. CPC G09B 9/003; F42B 8/14

(57) ABSTRACT

Disclosed is systems and methods of simulating IEDs and munitions with an SUAV. One embodiment is a simulation of an SUAV that is used to directly deliver an TED. Another embodiment is a simulation of an SUAV that delivers IEDs by placing, dropping, or launching them from the SUAV. Additionally, the SUAV may be used to deliver other simulated hazardous devices such biological or chemical weapons, distraction devices or contraband.

### REFERENCE TO RELATED APPLICATION

This application claims priority to U.S. Provisional Application No. 62/504,812 entitled “System, Apparatus, and Method for Small Unmanned Aerial Vehicles Used for the Simulation of Improvised Explosive Devices and Other SUAV Transported Devices” filed May 11, 2017, which is entirely incorporated by reference.

### FIELD OF THE INVENTION

The present invention relates to a novel and inventive systems, apparatus, and methods of simulating the use of Improvised Explosive Devices (IEDs), and other related technologies (e.g., gas generators or releasers, flash/bang, or other pyrotechnic devices, biological agent releasers or other hazardous systems) delivered by the use of Small Unmanned Aerial Vehicles (SUAVs) for the purposes of creating realistic scenarios and environments for training military, law enforcement and first responder personnel as well as other individuals such as humanitarian aid workers or medical professionals who may be exposed to these hazards, as well as for test and evaluation of various techniques to enhance, detect, mitigate, intercept, or destroy SUAVs.

### BACKGROUND OF THE INVENTION

The use of IEDs and other hazardous devices in combat as well as against civilians, law enforcement, or other first responder personnel is a constantly evolving threat. As SUAV or drone technology becomes more advanced these types of devices are more and more commonly used to deliver IEDs and hazardous devices. In order to properly train military, law enforcement, and other personnel how to react and respond to this threat, it is necessary to create realistic, safe and effective simulated devices that perform as much like the actual threat as possible in order to use them in effective training scenarios. In addition, the test and evaluation of ancillary systems related to SUAVs, such as detection and countermeasures, is also vital, and systems of this nature will allow for the test and evaluation of these technologies. Further, these devices can be extensively used for the development of operational and response doctrines for the use of emerging technologies meant to interact with such devices.

### SUMMARY OF THE INVENTION

The present invention consists of the novel use of realistic IED Simulators with an SUAV as well as other training devices as needed. Two embodiments of methods of SUAV based IED delivery systems are disclosed. The first embodiment is of an SUAV that is used to directly deliver an IED. The second embodiment is of an SUAV that delivers IEDs by placing, dropping, or launching them from the SUAV. Additionally, the SUAV may be used to deliver other simulated hazardous devices such biological or chemical weapons, distraction devices or contraband.

With the foregoing and other objects in view, there is provided, in accordance with the invention, a system for providing an immersive training scenario for military, law enforcement, and other personnel, the system including at least one small unmanned aerial vehicle (SUAV); and at least one of a simulated explosive and a simulated munition releasably coupled to the SUAV.

In accordance with another feature, an embodiment of the present invention may further include a release mechanism disposed on a bottom portion of the SUAV; and a remote control station wirelessly communicatively coupled to the SUAV and operably configured to selectively, responsive to a user input, operate or release the release mechanism for delivering the simulated explosive or the simulated munition to a target area disposed below the SUAV.

In accordance with yet another feature, an embodiment of the present invention may also include a launching device coupled to the SUAV; and a remote control station wirelessly communicatively coupled to the SUAV and operably configured to selectively, responsive to a user input, launch the simulated explosive or the simulated munition to a target area disposed below the SUAV.

In accordance with a further feature of the present invention, the remote control station is formed as a portable remote control device with at least one actuator operably configured to activate the launching device in response to the user input received via the actuator.

In accordance with yet a further feature of the present invention, the launching device is moveable within at least a 90 degree range, via user input at the remote control station, so as to selectively direct the launching device at the target area.

In yet a further embodiment of the present invention, the launching device is moveable along more than one axis of rotation.

In accordance with yet another embodiment of the present invention, the simulated explosive and the simulated munitions are sized, shaped, and operably configured to attached to a bottom portion of the at least one SUAV so as to not disrupt the center of gravity of the SUAV.

In accordance with another feature of the present invention, the simulated explosive or the simulated munition are formed as at least one of a pyrotechnic device, a propane device, and a pneumatic device.

In accordance with an additional feature of the present invention, the simulated explosive or the simulated munitions are operably configured to cause minimal to zero damage to the SUAV when attached thereto and when, fired, launched, or released.

In accordance with yet another feature of the present invention, the simulated explosive or the simulated munitions includes at least one pair of pneumatic simulators having corresponding recoil forces operable to substantially cancel each other when fired simultaneously from the at least one SUAV so as to promote a stable flight of the SUAV even during firing.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 depicts an embodiment of an SUAV with an TED simulator attached.

FIG. 2 depicts an embodiment of an SUAV with munition simulators attached.

### DETAILED DESCRIPTION OF THE INVENTION

Although the invention is illustrated and described herein as embodied in a system, apparatus, and method for small unmanned aerial vehicles used to simulate improvised explosive devices in a training environment, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

It is to be understood that the disclosed embodiments herein are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the figures, in which like reference numerals are carried forward. The figures, unless otherwise indicated, of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the SUAV.

The accompanying figure(s), where like reference numerals refer to identical or functionally similar elements throughout the separate views and which together with the detailed description below are incorporated in and form part of the specification, serve to further illustrate various embodiments and explain various principles and advantages all in accordance with the present invention.

The figure(s) show several advantageous features of the present invention, but the invention can be provided in several shapes, sizes, combinations of features and components, and varying numbers and functions of the components.

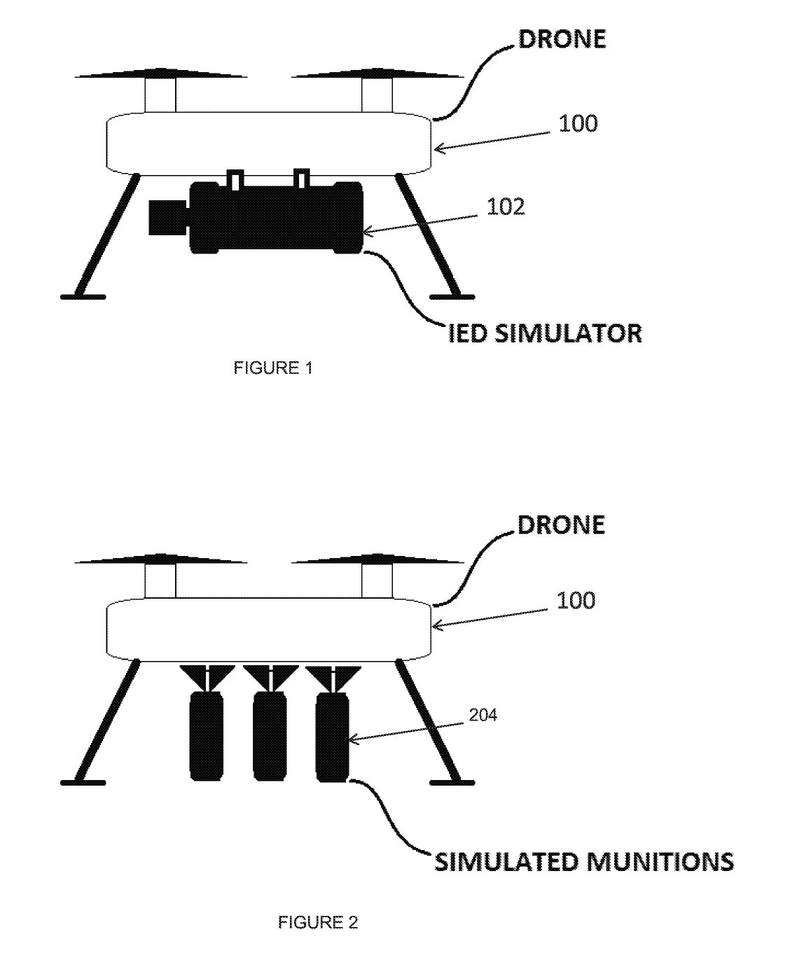

Embodiments of the present invention are illustrated in FIGS. 1 and 2, which show several advantageous features of the present invention, but, as will be described below, the invention can be provided in several shapes, sizes, combinations of features and components, and varying numbers and functions of the components. The first example of an immersive training system, as shown in FIG. 1, includes a drone or small unmanned aerial vehicle (SUAV) 100 with an IED simulator 102 attached thereto. The second example of an immersive training system, as shown in FIG. 2, includes SUAV 100 with a plurality of simulated munitions 204 attached thereto. While three simulated munitions 204 are shown, another number of simulated munitions can be deployed. For example, 1, 2, 4, 5, 6, or more.

In one embodiment, for simulating an IED delivered and attached to the SUAV 100 an IED simulator 102 or other related device may be attached to the SUAV 100 in such a manner as to allow SUAV 100 to still function. Stated another way, the configuration of the simulator 102 or 204 should be such that attachment to the SUAV 100 and deliverance of the simulator 102 or 204 to a target area preferably does not substantially adversely affect the stability of the SUAV in flight.

Typical IED simulators 102 and simulated munition 204 fall into one of three categories: pyrotechnic, propane (or other flammable gas) with (or without additional) oxygen, and pneumatic devices using compressed air, CO2 or other gas. Using a simulator 102, 204 of one of these types would allow the SUAV 100 to be flown to the area or location desired where the simulator 102, 204 would be detonated or fired creating the simulated effects of an IED explosion without undue hazard to exposed personnel or equipment, notably the SUAV 100. Preferably, the simulated IEDs create a noise, a visual indicator of an explosion (e.g. a fire ball, smoke, or a flash of light), or both when triggered or otherwise activated.

Other possible payloads include simulated devices for the release of biological or chemical agents, contraband, means of causing distraction or obscurance (flash/bang generators, noise makers, smoke generators, etc.) or other payloads that would be of value for simulation in this operation milieu. The payload may also include devices designed to affect the environment including to obscure or distract personnel and sensors.

One advantage of this invention may be that a realistic scenario involving an SUAV 100 delivered IED simulator 102 or other device can be performed without the costs and hazards of using actual devices. If used properly, the simulators should cause minimal to zero damage to the SUAV 100 and those in proximity to the system. A variety of means of attachment are envisioned that would both ensure secure/safe and realistic operation, while still allowing for an acceptable operating regime for the SUAV 100. Preferably, the IED simulator 102 or simulated munitions 204 are releasably coupled to the SUAV 100 by a release mechanism or a launching device. The launching device is preferably moveable within at least a 90 degree, 135 degree, or 180 degree range, so as to selectively direct the launching device at the target area. Furthermore, the launching device is preferably able to rotate about three axes of rotation.

Embodiments of this type of the invention may include but are not limited to: (1) A pneumatic IED simulator 102 attached to the frame or landing gear of the SUAV 100 and triggered remotely either by the remote controller for the SUAV 100 or a separate wireless device, or other means allowing for command or automated functioning; (2) An oxygen propane simulator attached and triggered in the same manner; (3) A pair of pneumatic simulators arranged so that recoil forces would significantly cancel each other when fired simultaneously, (4) A pyrotechnic charge attached to the framework or landing apparatus and fired similarly or automatically when the SUAV 100 reaches a predetermined position, altitude or proximity to a remote sensor; (5) A smoke generator, noise generator or other simulated or real device that can be transported and function with or in conjunction with the SUAV; or (6) Other combinations of these types of simulators, attachment methods and triggering methods.

An SUAV 100 can also be used to deliver simulated IEDs 102 that may also be used to trigger blast effects from the IED simulator 102. One embodiment of this type of the invention may include the SUAV 100 carrying a payload of one or more simulated munitions 204 that can be released or dropped from the SUAV 100 on demand or upon arrival at a particular location, altitude or within a defined proximity of an additional remote sensor or device. Such an embodiment would be used to simulate the use of the SUAV 100 to deliver munitions in an attack by dropping them on targeted personnel, structures or equipment. The realism of such simulated attack would be enhanced by interfacing the dropped simulated IEDs 102 with an IED simulator that would produce the simulated blast and explosive effects of the munitions once they hit the ground.

Preferably, the IED simulator 102 or simulated munitions 204 can be triggered by a remote control device with an actuator. For example, the remote control device can be held by an SUAV operator on the ground and the IED simulator 102 or simulated munitions 204 can be triggered once the SUAV reaches the target destination. The triggering may include activating the simulated explosion of the IED simulator 102 or releasing or launching one or more of the munitions 204. The IED simulator 102 or simulated munitions 204 may be triggered by a proximity sensor positioned on the ground remote from the SUAV. For example, the SUAV may be able to detect the proximity sensor within a distance range and, in response to the detection, fire or release the IED simulator 102 or the munition 204. In other embodiments, the SUAV may be autonomous and may be able to determine the precise time and location of delivery and/or actuation of the IED simulator 102 or the munition 204 based on sensed conditions. The sensed conditions may include, for example, weather conditions, ground conditions, terrain, troop locations, locations of other SUAVs, incoming threats, locations building or other structures, or anther sensed condition. Multiple SUAVs may work together independent of human intervention to carry out missions or deliver payloads.

Preferably the SUAV 100 includes at least one pair of pneumatic simulators having corresponding recoil forces operable to substantially cancel each other out when fired simultaneously from the SUAV so as to promote a stable flight of the SUAV even during firing.

SUAV 100 may be adapted to be added to a multiple integrated laser engagement system (MILES) or other combat simulation system. SUAV 100 may be adapted to send, receive, and react to combat simulation signals. Additionally, SUAV 100 may be able to react to or record occurrences of interactions with anti-drone devices or technologies. While an aerial vehicle is described herein the vehicle may be an unmanned water born vehicle or an unmanned ground vehicle. In other embodiments, the vehicle may be manned.

Other embodiments and uses of the invention will be apparent to those skilled in the art from consideration of the specification and practice of the invention disclosed herein. All references cited herein, including all publications, U.S. and foreign patients and patient applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.” All examples illustrate embodiments of the invention, but should not be viewed as limiting the scope of the invention.

What is claimed is:

1. A system for providing an immersive training scenario, the system comprising:
a Small Unmanned Aerial Vehicle (SUAV); and
at least one of a simulated explosive and a simulated munition releasably coupled to the at least one SUAV.

2. The system of claim 1, further comprising:
a release mechanism coupled to a bottom portion of the SUAV adapted to releasably couple at least one of the simulated explosive and the simulated munition to the SUAV; and
a remote control in wireless communication with the SUAV and operably configured to trigger the release mechanism for delivering the at least one of the simulated explosive and the simulated munition to a target area disposed below the SUAV.

3. The system of claim 1, further comprising:
a launching device coupled to the SUAV; and
a remote control in wireless communication with the SUAV and operably configured to launch the at least one of the simulated explosive and the simulated munition to a target area disposed below the SUAV.

4. The system of claim 3, wherein:
the remote control station is a portable remote control device with at least one actuator operably configured to activate the launching device in response to user input received via the actuator.

5. The system of claim 3, wherein:
the launching device is moveable within at least a 90 degree range, via user input at the remote control, so as to selectively direct the launching device at the target area.

6. The system of claim 1, wherein:
the at least one of the simulated explosive and the simulated munition is sized, shaped, and operably configured to attached to a bottom portion of the SUAV so as to not disrupt a center of gravity of the SUAV or impede control of the SUAV.

7. The system of claim 1, wherein:
the at least one of the simulated explosive and the simulated munition is at least one of a pyrotechnic device, a propane device, and a pneumatic device.

8. The system of claim 1, wherein:
the at least one of the simulated explosive and the simulated munition is operably configured to cause minimal to zero damage to the SUAV when attached thereto and when launched or released.

9. The system of claim 1, wherein:
the at least one of the simulated explosive and the simulated munition includes at least one pair of pneumatic simulators having corresponding recoil forces operable to substantially cancel each other out when fired simultaneously from the SUAV so as to promote a stable flight of the SUAV even during firing.

10. The system of claim 1, further comprising:
a proximity sensor positioned on the ground remote from the SUAV, the SUAV operably configured to detect the proximity sensor within a distance range and, in response to said detection, fire or release the at least one of the simulated explosive and the simulated munition.

11. A method of training personnel, canines, or other organisms to react or respond to explosive devices delivered by a Small Unmanned Aerial Vehicle (SUAV), comprising:
coupling at least one of a simulated explosive and a simulated munition releasably coupled to an SUAV;
manuvoring the SUAV to a target area; and
deploying the at least one of a simulated explosive and a simulated munition.

12. The method of claim 11, wherein a release mechanism is coupled to a bottom portion of the SUAV that is adapted to releasably couple at least one of the simulated explosive and the simulated munition to the SUAV, and further comprising:
triggering the release mechanism with a remote control in wireless communication with the SUAV.

13. The method of claim 11, wherein a launching device is coupled to the SUAV, and further comprising:
Triggering the launch device with a remote control in wireless communication with the SUAV.

14. The method of claim 13, wherein:
the remote control is a portable remote control device with at least one actuator operably configured to activate the launching device in response to user input received via the actuator.

15. The method of claim 13, wherein:
the launching device is moveable within at least a 90 degree range, via user input at the remote control, so as to selectively direct the launching device at the target area.

16. The method of claim 11, wherein:
the at least one of the simulated explosive and the simulated munition is sized, shaped, and operably configured to attached to a bottom portion of the SUAV so as to not disrupt a center of gravity of the SUAV or impede control of the SUAV.

17. The method of claim 11, wherein:
the at least one of the simulated explosive and the simulated munition is at least one of a pyrotechnic device, a propane device, and a pneumatic device.

18. The method of claim 11, wherein:
the at least one of the simulated explosive and the simulated munition is operably configured to cause minimal to zero damage to the SUAV when attached thereto and when launched or released.

19. The method of claim 11, wherein:
the at least one of the simulated explosive and the simulated munition includes at least one pair of pneumatic simulators having corresponding recoil forces operable to substantially cancel each other out when fired simultaneously from the SUAV so as to promote a stable flight of the SUAV even during firing.

20. The method of claim 11, wherein:
a proximity sensor is positioned on the ground remote from the SUAV, the SUAV operably configured to detect the proximity sensor within a distance range and, in response to said detection, fire or release the at least one of the simulated explosive and the simulated munition.
